(19) United States
(12) Patent Application Publication
(10) Pub. No.: US 2013/0315087 A1
(43) Pub. Date: Nov. 28, 2013

(54) MOBILE TERMINAL, MICRO BASE STATION, MACRO BASE STATION, COMMUNICATION SYSTEM AND COMMUNICATION METHOD

(71) Applicant: Fujitsu Limited, Kawasaki-shi (JP)

(72) Inventors: Yi ZHANG, Beijing (CN); Yuantao ZHANG, Beijing (CN); Yuanrong LAN, Beijing (CN); Hua ZHOU, Beijing (CN); Jianming WU, Beijing (CN)

(73) Assignee: Fujitsu Limited, Kawasaki-shi (JP)

(21) Appl. No.: 13/955,729

(22) Filed: Jul. 31, 2013

Related U.S. Application Data
(63) Continuation of application No. PCT/CN2011/070974, filed on Feb. 14, 2011.

(51) Int. Cl. H04W 72/04

(52) U.S. Cl. CPC H04W 72/0446
USPC 370/252

(57) ABSTRACT

A mobile terminal, a micro base station, a macro base station, a communication system and a communication method. The method includes receiving from a micro base station a designation of specific subframe and a designation of feedback mode; judging whether a current subframe is a specific subframe designated by the micro base station; and measuring and feeding back the channel condition of the current subframe in a joint transmission feedback mode when the current subframe is the specific subframe designated by the micro base station, and measuring and feeding back the channel condition of the current subframe in a feedback mode designated by the micro base station when the current subframe is not the specific subframe designated by the micro base station.

### CROSS-REFERENCE TO RELATED APPLICATIONS

This application is a continuation of International Application PCT/CN2011/070974, filed Feb. 14, 2011 and now pending, the entire contents of which are incorporated herein by reference.

### TECHNICAL FIELD

The present invention relates to transmission technologies in a communication system, and particularly, to an LTE-A heterogeneous network system; a mobile terminal, a micro base station and a macro base station in the LTE-A heterogeneous network system; and methods used in the mobile terminal, the micro base station and the macro base station.

### BACKGROUND

The Long Term Evolution (LTE) of the 3GPP continues to use the traditional homogeneous network which is constructed by a hexagonal cellular system. In order to further improve the system capacity, the next generation wireless communication system, the Advanced LTE (LTE-A), introduces the heterogeneous network. The LTE-A system may be composed of a macro cell, a femto cell, a pico cell, a Remote Radio Head (RRH) and a relay. By deploying new wireless nodes, the LTE-A system not only improves the system capacity, but also provides better services to the users of special areas and optimizes the system performance. However, the deployment of the new nodes causes interferences to the users of the originally deployed cells, and even covers some holes. Therefore, an enhanced Inter-Cell Interference Coordination (eICIC) method is required to further optimize the system performance.

Under the macro cell and micro cell (including femto cell, pico cell, RRH, relay, etc.) mixed cell scenario, in order to improve the cell capacity, the cell extension technology is adopted. FIG. 1 is a schematic diagram illustrating a region extension of a cell under a mixed cell scenario. As illustrated in FIG. 1, by changing the cell selection criterion of the mobile station, a part of mobile stations (sometimes referred to as mobile terminals) served by the macro cell are varied to be served by the micro cell. The mobile stations at the cell extension section are strongly interfered with by the macro cell, thus an enhanced interference coordination scheme is required to ensure the reliable operation of those mobile stations. The Almost Blank Subframe (ABS) scheme is used to reduce interferences to the control channel and the data channel. In the ABS, no transmission is made for the PDCCH and the PDSCH of the macro cell, and corresponding PDCCH and PDSCH of the micro cell will not be interfered with by the macro cell, thus the user in the extension region of the micro cell can perform a reliable transmission in the ABS. For the region extension technology, when a large deviation value is used, the reception of the control channel of the micro cell is unreliable, and when a small deviation value is used, the reception of the control channel of the micro cell is reliable.

In order to support the operation of the ABS, two measurement subsets are defined. One of the subsets is used to measure the interference information of corresponding ABS, and the other subset is used to measure the interference information of corresponding non-ABS. The user terminal feeds back corresponding channel status information on the configured measurement subset.

In the studying process of different embodiments herein, the inventor finds that although the conventional ABS method can reduce the interference on the signal transmitted by the base station of the micro cell from the signal transmitted by the base station of the macro cell, the disadvantage is that no more help can be given to the service provided by the micro cell while the macro cell resources are idle, i.e., it only achieves noninterference, without making any contribution to the improvement of the service of the micro cell.

### SUMMARY

Certain embodiments are proposed with respect to the above condition of the prior art, so as to overcome or relieve one or more shortages of the prior art.

According to an aspect of certain embodiments, a communication method used in a mobile terminal is provided, comprising the steps of: receiving from a micro base station a designation of specific subframe and a designation of feedback mode; judging whether a current subframe is a specific subframe designated by the micro base station; measuring and feeding back the channel condition of the current subframe in a joint transmission feedback mode when the current subframe is the specific subframe designated by the micro base station, and measuring and feeding back the channel condition of the current subframe in a feedback mode designated by the micro base station when the current subframe is not the specific subframe designated by the micro base station.

According to another aspect, a mobile terminal is provided, comprising: a receiving unit configured to receive from a micro base station a designation of specific subframe and a designation of feedback mode; a judging unit configured to judge whether a current subframe is a specific subframe designated by the micro base station; and a feeding back unit configured to measure and feed back the channel condition of the current subframe in a joint transmission feedback mode when the current subframe is the specific subframe designated by the micro base station, and measure and feed back the channel condition of the current subframe in a feedback mode designated by the micro base station when the current subframe is not the specific subframe designated by the micro base station.

According to another aspect, a method used in a micro base station is provided, comprising the steps of: receiving from a macro base station information about Almost Blank Subframe (ABS) allocated to the macro base station; designating a feedback mode, and designating a subframe used by the micro base station and corresponding to the ABS as a specific subframe; transmitting information about the specific subframe and the feedback mode to a mobile terminal, transmitting data to the mobile terminal in the specific subframe, and transmitting to the macro base station data to be transmitted by the macro base station to the mobile terminal in the ABS and a location of the data in the ABS; processing the channel feedback information as channel feedback information in a joint transmission feedback mode when the received channel feedback information is for the specific subframe, and processing the channel feedback information as channel feedback information in a feedback mode designated by the designating when the received channel feedback information is not for the specific subframe.

According to another aspect, a micro base station is provided, comprising: a receiving unit configured to receive from a macro base station information about ABS allocated to the macro base station, and receive channel feedback information from a mobile terminal; a designating unit configured to designate a feedback mode, and designate a subframe used by the micro base station and corresponding to the ABS as a specific subframe; a transmitting unit configured to transmit information about the specific subframe and the feedback mode to the mobile terminal, transmit data to the mobile terminal in the specific subframe, and transmit to the macro base station data to be transmitted by the macro base station to the mobile terminal in the ABS and a location of the data in the ABS; a feedback processing unit configured to process the channel feedback information as channel feedback information in a joint transmission feedback mode when the received channel feedback information is for the specific subframe, and process the channel feedback information as channel feedback information in a feedback mode designated by the designating unit when the received channel feedback information is not for the specific subframe.

According to another aspect, a macro base station is provided, comprising: a first transmitting unit configured to transmit information about ABS to a micro base station; a receiving unit configured to receive from the micro base station data and information about a location of the data in the ABS; and a second transmitting unit configured to transmit the data received by the receiving unit in the ABS according to the location designated by the information about the location received by the receiving unit.

According to another aspect, a communication system is provided, comprising the aforementioned mobile terminal, micro base station and macro base station.

The above general descriptions and the following detailed descriptions made with reference to the drawings are all schematic, rather than limitations to the protection scope of the present invention.

### BRIEF DESCRIPTION OF THE DRAWINGS

The above and other objects, characteristics and advantages of certain embodiments will be understood more clearly through the following detailed descriptions made with reference to the drawings.

FIG. 1 is a schematic diagram illustrating a region extension of a cell under a mixed cell scenario;

FIG. 2 is a schematic diagram illustrating a macro-micro multipoint cooperation communication system according to certain embodiments;

FIG. 3 is a flowchart illustrating an operation of a macro-micro multipoint cooperation transmission system according to an embodiment;

FIG. 4 is a schematic diagram illustrating a mobile phone used as an example of mobile terminal according to an embodiment;

FIG. 5 is a schematic functional block diagram of a mobile station according to an embodiment;

FIG. 6 is a schematic functional block diagram of a micro base station according to an embodiment;

FIG. 7 is a schematic functional block diagram of a macro base station according to an embodiment;

FIG. 8 is a flowchart illustrating a processing performed at a mobile terminal according to an embodiment;

FIG. 9 is a flowchart illustrating a processing performed at a micro base station according to an embodiment; and

FIG. 10 is a comparison diagram illustrating a conventional eICIC scheme and an ABS data transmitting condition in a technical solution according to certain embodiments.

### DESCRIPTION OF THE EMBODIMENTS

Several embodiments herein are detailedly described as follows with reference to the drawings. To be noted, features described and/or illustrated with respect to one embodiment may be used in the same or similar way in one or more other embodiments, combined with or in substitution of the features in other embodiments.

To be emphasized, the term “comprise/include” and “comprising/including” used herein specifies the presence of feature, integer, step or component, not excluding the presence or addition of one or more other features, integers, steps or components.

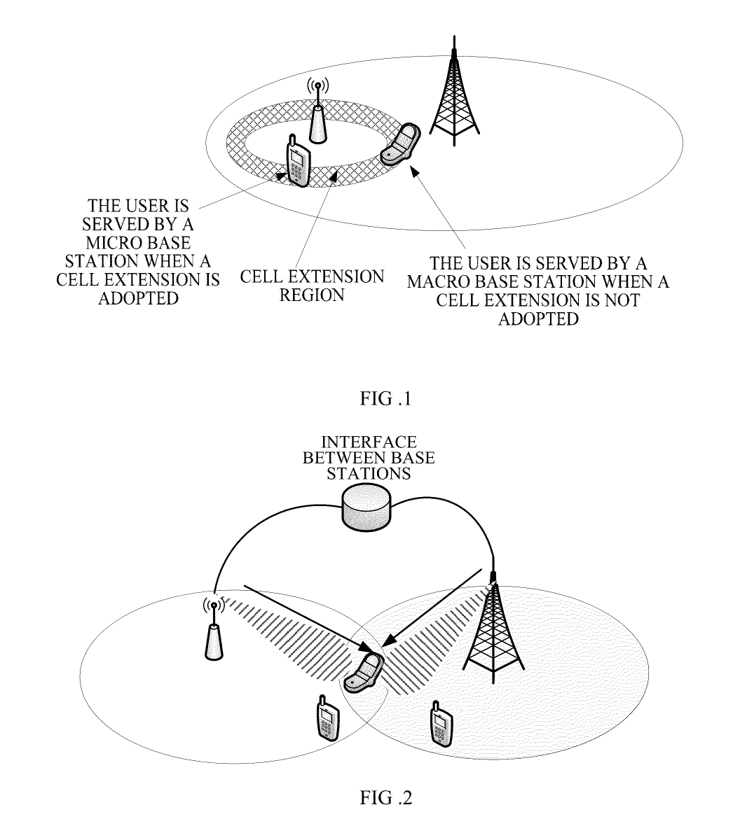

Several embodiments herein are applicable to the heterogeneous network, where a large cell includes one or more small cells. The large cell is referred to as the macro cell, and the small cell is referred to as the micro cell. The micro cell for example may be a femto cell, a pico cell, an RRH, a relay, etc. The base station used in the micro cell is referred to as the micro base station, and the base station used in the macro cell is referred to as the macro base station. The communication system to which the embodiment is applicable for example is illustrated in FIG. 1. FIG. 1 is also exemplary, and for example more micro base stations, macro base stations and users may be available.

FIG. 2 is a schematic diagram illustrating a macro-micro multipoint cooperation communication system (also referred to as joint transmission communication system). As illustrated in FIG. 2, the base stations are connected to each other through an interface (e.g., X2 interface). Firstly, the macro base station or the micro base station coordinates to determine whether a cooperation needs to be performed between the macro base station and the micro base station. When is determined that a cooperation needs to be performed, for example the scheduling location information, the coordination information, the data of the cooperative transmission, etc. may be transmitted between the macro base station and the micro base station, and the mobile terminal may be indicated to enter the Comp mode. In order to achieve the cooperative transmission, the mobile station shall measure the status information of the channel from each base station to the mobile station, and feed back to the service base station (micro base station).

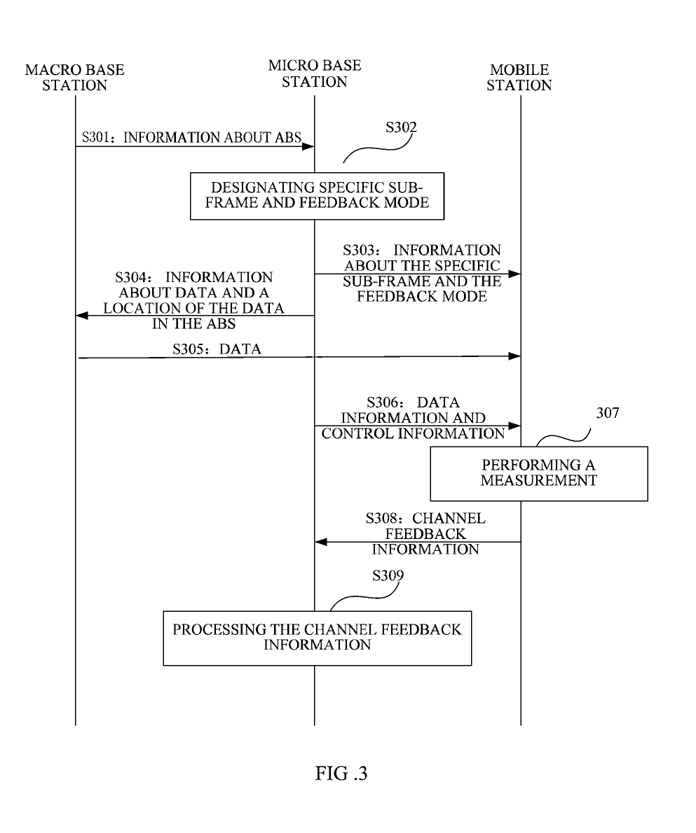

FIG. 3 is a flowchart illustrating an operation of a macro-micro multipoint cooperation transmission system according to an embodiment.

As illustrated in FIG. 3, firstly in step S301, a macro base station transmits, to micro base station, information about Almost Blank Subframe (ABS). Next in step S302, a micro base station designates a feedback mode, and designates, according to the information about the ABS, a subframe used by the micro base station and corresponding to the ABS as a specific subframe. Next, in step S303, the micro base station transmits information about the specific subframe and the feedback mode to the mobile station. Further in step S304, the micro base station transmits data and information about the location of the data in the ABS to the macro base station, and the data is to be transmitted from the macro base station to the mobile station in the ABS. Next, in step S305, the macro base station transmits the data received from the micro base station to the mobile station in the ABS, according to the received information about the location of the data in the ABS. Meanwhile, in step S306, the micro base station transmits the same data and related control information to the mobile station. The mobile station measures the channel quality according to the received information about the feedback mode in step S307, and transmits the related information as channel feedback information to the micro base station in step S308. In step S309, the micro base station processes the channel feedback information, e.g., judging whether a cooperation with the macro base station is still necessary.

In one embodiment, the feedback mode may be a joint transmission feedback mode for the multi-point cooperation joint transmission, a coordinative scheduling/coordinative beam forming (CS/CB) feedback mode for the multi-point cooperation CS/CB mode, or a non-multi-point cooperation transmission feedback mode for the non-multi-point cooperation transmission.

To be noted, the above descriptions are just schematic, and a person skilled in the art shall appreciate that the order of the above steps can be adjusted, and some steps may be performed concurrently.

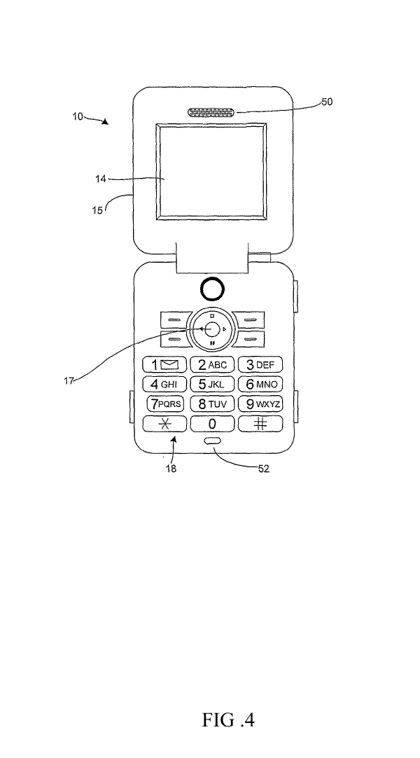

FIG. 4 is a schematic diagram illustrating a mobile phone used as an example of mobile terminal according to an embodiment. The example of the mobile terminal is not limited to the mobile phone. The mobile terminal may also be any device having a communication capability, such as game machine, PDA, portable computer, etc. As illustrated in FIG. 4, a mobile phone 10 may be a flip phone having a cover 15 movable between an open position and a closed position. In FIG. 4, the cover 15 is illustrated as being located at the open position. It shall be appreciated that the mobile phone 10 may be other structure such as a “bar phone” or a “slide phone”.

The mobile phone 10 may include a display 14 that displays information such as operating state, time, telephone number, telephone directory, menus, etc. to the user, so that the user can utilize various features of the electronic device 10. The display 14 may be further configured to visually display the content received by the electronic device 10 and/or retrieved from a memory (not illustrated) of the mobile phone 10. The display 14 may be configured to present images, videos and other graphics (e.g., photos, mobile TV programs and game-related videos) to the user.

A keypad 18 provides multiple user input operations. For example, the keypad 18 may include alphanumeric keys that allow alphanumerical information (e.g., telephone number, telephone list, telephone directory, notepad, text, etc.) to be input. In addition, the keypad 18 may include specific function keys 17, such as a “call send” key for initiating or answering a phone call, and a “call end” key for ending or hanging up the phone call. The specific function keys may further include a menu navigation key and a selection key which conveniently perform navigation through menus displayed on the display 14. For example, a pointing device and/or a navigation key may be provided to receive a directional input from the user. In addition, the display 14 and the keypad 18 may be used in combination to realize the soft key function. The mobile phone 10 further includes parts essential for realizing its functions, such as an antenna, a microcontroller, a speaker 50 and a microphone 52.

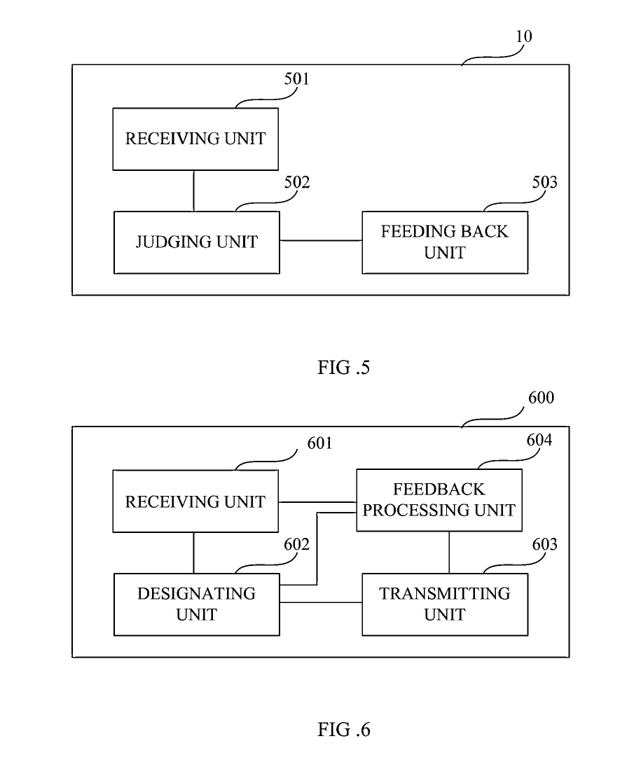

FIG. 5 is a schematic functional block diagram of a mobile station according to an embodiment.

As illustrated in FIG. 5, a mobile phone 10 according to an embodiment includes a receiving unit 501, a judging unit 502 and a feeding back unit 503. The receiving unit 501 receives from a micro base station a designation of specific subframe and a designation of feedback mode. As mentioned above, in one embodiment, the specific subframe is a subframe used by the micro base station and corresponding to an ABS of a macro base station. The feedback mode is a joint transmission feedback mode or a CS/CB feedback mode for multi-point cooperation joint transmission mode, or a non-multi-point cooperation transmission feedback mode for the non-multi-point cooperation transmission, wherein the non-multi-point cooperation transmission feedback mode (also referred to as the normal feedback mode) includes various transmission modes supported by the LTE-A, such as single antenna port mode, transmission diversity mode, open loop cyclic delay diversity mode, closed loop space division multiplexing mode, multi-user MIMO mode, uniflow beam forming mode, double flow beam forming mode, etc. Next, the receiving unit receives the data from the micro base station and the macro base station. The judging unit 502 judges whether a current subframe is a specific subframe designated by the micro base station. The feeding back unit 503 measures and feeds back the channel condition of the current subframe in a joint transmission feedback mode when the current subframe is the specific subframe designated by the micro base station. In that case, a measurement and a feedback are performed independently from the feedback mode designated by the micro base station. For example, even the micro base station designates the non-multi-point cooperation transmission feedback mode, the feeding back unit 503 still measures and feeds back the channel condition of the current subframe in the joint transmission feedback mode when the judging unit 502 judges that the current subframe is the specific subframe designated by the micro base station. On the other hand, the feeding back unit 503 measures and feeds back the channel condition of the current subframe in a feedback mode designated by the micro base station when the current subframe is not the specific subframe designated by the micro base station.

In addition, the receiving unit receives data from both the macro base station and the micro base station at the specific subframe designated by the micro base station, according to the control information received from the micro base station.

FIG. 6 is a schematic functional block diagram of a micro base station according to an embodiment. As illustrated in FIG. 6, a micro base station 600 according to an embodiment includes a receiving unit 601, a designating unit 602, a transmitting unit 603 and a feedback processing unit 604.

The receiving unit 601 receives from a macro base station information about ABS allocated to the macro base station, and receives channel feedback information from a mobile terminal.

The designating unit 602 designates a feedback mode, and designates a subframe used by the micro base station and corresponding to the ABS as a specific subframe.

The transmitting unit 603 transmits information about the specific subframe and the feedback mode to the mobile terminal, and transmits to the macro base station data to be transmitted by the macro base station to the mobile terminal in the ABS and a location of the data in the ABS. In the specific subframe, the transmitting unit further transmits to the mobile terminal the data the same as those transmitted to the macro base station.

The feedback processing unit 604 processes the channel feedback information as channel feedback information in a joint transmission feedback mode when the channel feedback information received by the receiving unit 601 from the mobile terminal is for the specific subframe, and processes the channel feedback information as channel feedback information in a feedback mode designated by the designating unit when the channel feedback information received by the receiving unit 601 is not for the specific subframe.

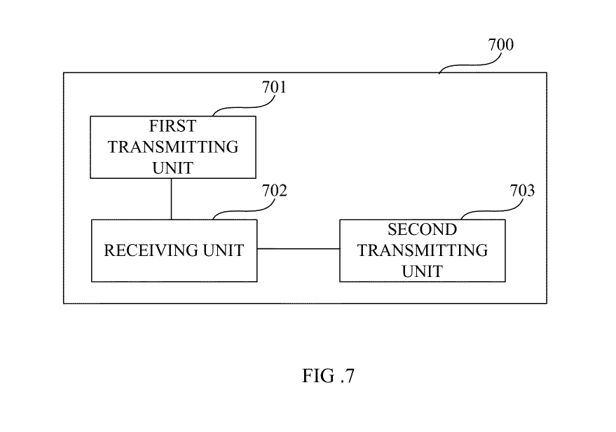

FIG. 7 is a schematic functional block diagram of a macro base station according to an embodiment. As illustrated in FIG. 7, a macro base station 700 according to an embodiment includes a first transmitting unit 701, a receiving unit 702 and a second transmitting unit 703.

The first transmitting unit 701 transmits information about ABS to a micro base station; the receiving unit 702 receives, from the micro base station, data to be transmitted to the mobile station and information about a location of the data in the ABS; and the second transmitting unit 703 transmits, in the ABS according to a location designated by the information about the location of the data in the ABS received by the receiving unit, the data received by the receiving unit.

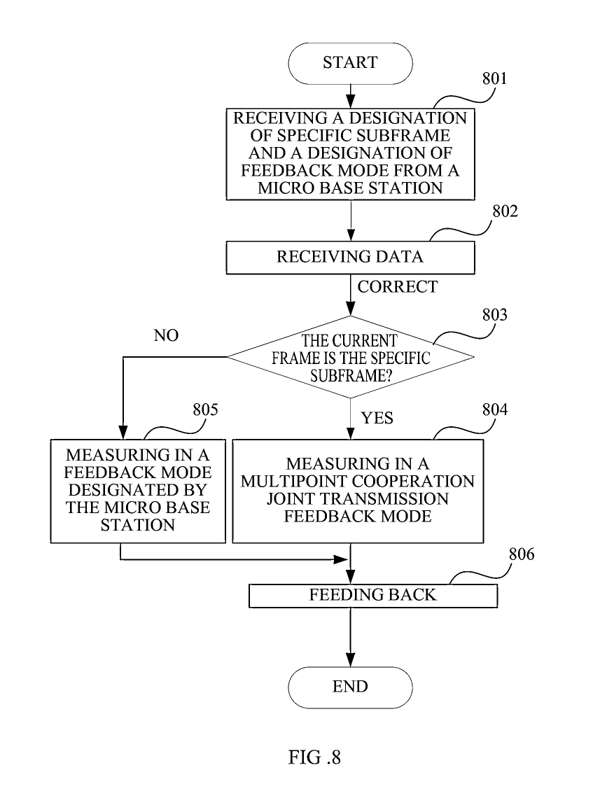

FIG. 8 is a flowchart illustrating a processing performed at a mobile terminal according to an embodiment. As illustrated in FIG. 8, firstly in step S801, a designation of specific subframe and a designation of feedback mode are received from a micro base station. Next, in step S802, data from both the micro base station and the macro base station are received. Next, in step S803, it is judged whether a current subframe received from the micro base station is a specific subframe, i.e., whether the current subframe is a subframe corresponding to the ABS transmitted by the macro base station. In one embodiment, the micro base station may transmit the information about the serial number (one form of designation of the specific subframe) of the specific subframe in the frame structure to the mobile terminal in advance. For example, when one frame includes ten subframes, data 2 and 8 for example may be transmitted, which indicates that the 3^{rd} and the 9^{th} subframes in the frame are the specific subframes. When the mobile station determines that the current subframe is the 3^{rd} subframe or the 9^{th} subframe, the current subframe may be determined as the specific subframe. When it is judged in step S803 that the current subframe is the specific subframe, the channel condition is measured in step S804 in the macro-micro multipoint cooperation joint transmission feedback mode. On the other hand, when it is judged in step S803 that the current subframe is not the specific subframe, the channel condition is measured in step S805 in the feedback mode designated by the micro base station. Next, in step S806, the channel feedback information is fed back to the micro base station.

The operation in FIG. 8 shall be understood in conjunction with the flowchart of FIG. 3. For example, S801 is corresponding to S304, S802 is corresponding to S305 and S306. Other steps are corresponding to S307 and S308.

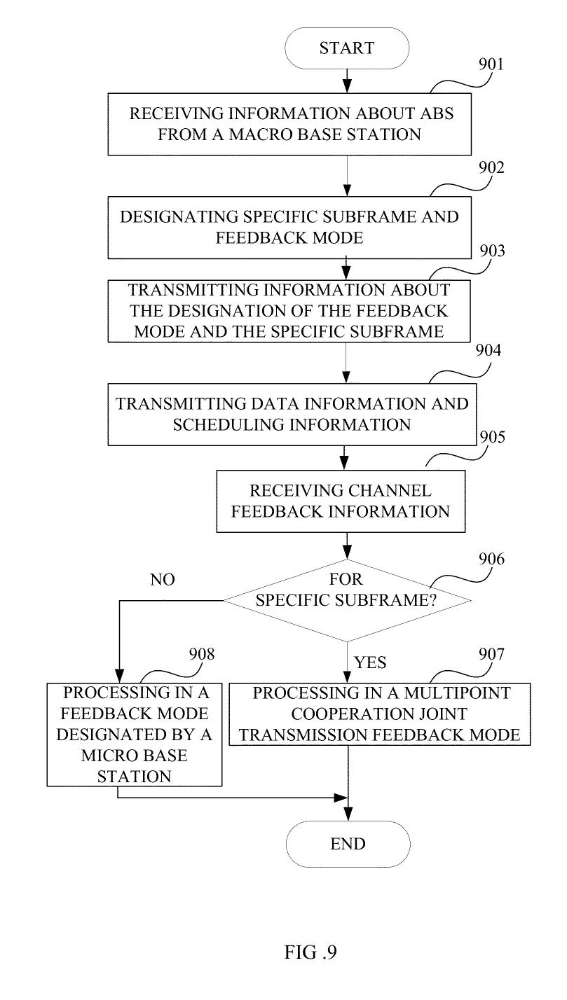

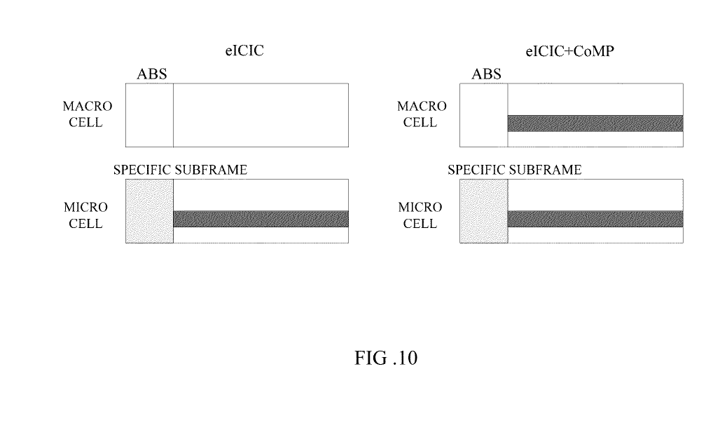

FIG. 9 is a flowchart illustrating a processing performed at a micro base station according to an embodiment. As illustrated in FIG. 9, firstly in step S901, information about ABS is received from a macro base station. In one embodiment, the macro base station may transmit information about the serial number of the ABS in the frame structure to the micro base station. For example, when one frame includes ten subframes, data 2 and 8 for example may be transmitted, which indicates that the 3^{rd} and the 9^{th} subframes in the frame are the ABSs. Next, in step S902, the micro base station designates the specific subframe and the feedback mode. For example, when the 3^{rd} and the 9^{th} subframes in the frame structure used by the macro base station are the ABSs, the 3^{rd} and the 9^{th} subframes in the frame structure used by the micro base station are designated as the specific subframes correspondingly. The feedback mode may be a joint transmission feedback mode, a CS/CB feedback mode or a non-multi-point cooperation transmission feedback mode. Next, in step S903, information about the feedback mode and the designation of the specific subframe are transmitted to the mobile terminal. Next, in step S904, data information and scheduling information is transmitted to the mobile terminal. In step S905, channel feedback information is received from the mobile terminal. In step S906, it is judged whether the channel feedback information from the mobile station is for the specific subframe. When it is judged in step S906 that the channel feedback information from the mobile station is for the specific subframe, in step S907 the channel feedback information is processed in the joint transmission feedback mode. On the other hand, when it is judged in step S906 that the channel feedback information from the mobile station is not for the specific subframe, in step S908 a processing is made in a feedback mode designated to the mobile terminal.

FIG. 10 is a comparison diagram illustrating a conventional eICIC scheme and an ABS data transmitting condition in a technical solution according to several embodiments. The left part of FIG. 10 illustrates a schematic diagram where an ABS in the conventional eICIC scheme solves interference. As can be seen from the drawing, under the normal condition, no data is transmitted in the ABS for the macro base station. The right part of FIG. 10 illustrates a technical solution according several embodiments. As can be seen from the drawing, data is transmitted in the ABS for the macro base station. As can be seen from FIG. 10, the base station of the macro cell also transmits the same information to the mobile station in the ABS, thereby improving the cell edge throughput.

In another embodiment, the micro base station may transmit activation information to the mobile terminal. For example, the specific flag bit may be set as 1 or 0 by appointment. For example, only when the specific flag bit is set as 1 by appointment, i.e., the activation information indicates an effective value, the mobile terminal performs the judgment in step S803. When the specific flag bit is set as 0 by appointment, i.e., the activation information indicates an ineffective value, the mobile terminal performs measurement and feedback in the feedback mode designated by the micro base station. Herein 0 and 1 are exemplary and other values may be appointed.

In one embodiment, the micro base station may determine the activation information to be transmitted according to whether the mobile terminal is located in a cell extension region. When the mobile terminal is located in the cell extension region, activation information indicating an effective value is transmitted; and when the mobile terminal is not located in the cell extension region, activation information indicating an ineffective value is transmitted.

In several embodiments, in non-ABS, the mobile station operates in the conventional CoMP mode, and the mobile terminal may operate in the JP mode or the CS/CB mode. The micro base station configures the CoMP operation mode for the mobile station. In ABS (in some embodiments, when the activation information indicates an effective value), the mobile station feeds back in the JP mode in measurement set 2, including PMI/CQI information, no matter how the micro base station configures the CoMP operation mode for the mobile station. In non-ABS, the mobile station feeds back in the CoMP operation mode configured by the system in measurement set 1.

Among the descriptions of several embodiments, the descriptions of the methods and steps may be taken to help the understanding of the devices and units, and the descriptions of the devices and units may be taken to help the understanding of the method and steps.

The above devices and methods may be implemented by hardware, or a combination of hardware and software. The present invention relates to a logic part readable program which when being executed by a logic part, enables the logic part to implement the aforementioned device or constituent parts, or enables the logic part to implement the aforementioned methods or steps. The logic part for example may be a field programmable logic part, a microprocessor, a processor used in the computer, etc. The several embodiments further relate to a storage medium for storing the above program, such as hard disc, magnetic disc, optical disc, DVD, flash, magnetic optical disc, memory card, memory stick, etc.

The present invention is described as above in conjunction with specific embodiments. But a person skilled in the art shall appreciate that those descriptions are just exemplary, rather than limitations to the protection scope of the present invention. A person skilled in the art can make various modifications and changes to the present invention based on the spirit and the principle of the present invention, and those modifications and changes also fall within the scope of the present invention.

What is claimed is:

1. A communication method used in a mobile terminal, comprising:
receiving from a micro base station a designation of specific subframe and a designation of feedback mode;
judging whether a current subframe is a specific subframe designated by the micro base station; and
measuring and feeding back the channel condition of the current subframe in a joint transmission feedback mode when the current subframe is the specific subframe designated by the micro base station, and measuring and feeding back the channel condition of the current subframe in a feedback mode designated by the micro base station when the current subframe is not the specific subframe designated by the micro base station.

2. The communication method according to claim 1, further comprising:
receiving data from both the micro base station and a macro base station at the specific subframe designated by the micro base station.

3. The communication method according to claim 2, wherein the data from the micro base station and the macro base station are the same data.

4. The communication method according to claim 1, further comprising receiving activation information from the micro base station, the judging judges whether the current subframe is the specific subframe designated by the micro base station only when the activation information indicates an effective value, and the feeding back feeds back the channel condition of the current subframe in the feedback mode designated by the micro base station when the activation information indicates an ineffective value.

5. The communication method according to claim 1, wherein the feedback mode designated by the micro base station comprises the joint transmission feedback mode, a coordinative scheduling/coordinative beam forming feedback mode and a normal feedback mode.

6. A mobile terminal, comprising:
a receiving unit configured to receive from a micro base station a designation of specific subframe and a designation of feedback mode;
a judging unit configured to judge whether a current subframe is a specific subframe designated by the micro base station; and
a feeding back unit configured to measure and feed back the channel condition of the current subframe in a joint transmission feedback mode when the current subframe is the specific subframe designated by the micro base station, and measure and feed back the channel condition of the current subframe in a feedback mode designated by the micro base station when the current subframe is not the specific subframe designated by the micro base station.

7. The mobile terminal according to claim 6, wherein the receiving unit receives data from both the micro base station and a macro base station at the specific subframe designated by the micro base station.

8. The mobile terminal according to claim 7, wherein the data from the micro base station and the macro base station are the same data.

9. The mobile terminal according to claim 6, wherein the receiving unit further receives activation information from the micro base station, the judging unit judges whether the current subframe is the specific subframe designated by the micro base station only when the activation information indicates an effective value, and the feeding back unit feeds back the channel condition of the current subframe in the feedback mode designated by the micro base station when the activation information indicates an ineffective value.

10. The mobile terminal according to claim 6, wherein the feedback mode designated by the micro base station comprises the joint transmission feedback mode, a coordinative scheduling/coordinative beam forming feedback mode and a normal feedback mode.

11. A method used in a micro base station, comprising:
receiving from a macro base station information about Almost Blank Subframe (ABS) allocated to the macro base station;
designating a feedback mode, and designating a subframe used by the micro base station and corresponding to the ABS as a specific subframe;
transmitting information about the specific subframe and the feedback mode to a mobile terminal, transmitting data to the mobile terminal in the specific subframe, and transmitting to the macro base station data to be transmitted by the macro base station to the mobile terminal in the ABS and a location of the data in the ABS;
receiving channel feedback information from the mobile terminal;
processing the channel feedback information as channel feedback information in a joint transmission feedback mode when the received channel feedback information is for the specific subframe, and processing the channel feedback information as channel feedback information in a feedback mode designated by the designating when the received channel feedback information is not for the specific subframe.

12. The method according to claim 11, further comprising:
judging whether the mobile terminal is located in an extension region of a micro cell served by the micro base station;
transmitting activation information indicates an effective value to the mobile terminal when the mobile terminal is located in the extension region of the micro cell served by the micro base station, and transmitting activation information indicates an ineffective value to the mobile terminal when the mobile terminal is not located in the extension region of the micro cell served by the micro base station.

13. A micro base station, comprising:
a receiving unit configured to receive from a macro base station information about Almost Blank Subframe (ABS) allocated to the macro base station, and receive channel feedback information from a mobile terminal;
a designating unit configured to designate a feedback mode, and designate a subframe used by the micro base station and corresponding to the ABS as a specific subframe;
a transmitting unit configured to transmit information about the specific subframe and the feedback mode to the mobile terminal, transmit data to the mobile terminal in the specific subframe, and transmit to the macro base station data to be transmitted by the macro base station to the mobile terminal in the ABS and a location of the data in the ABS;
a feedback processing unit configured to process the channel feedback information as channel feedback information in a joint transmission feedback mode when the received channel feedback information is for the specific subframe, and process the channel feedback information as channel feedback information in a feedback mode designated by the designating unit when the received channel feedback information is not for the specific subframe.

14. The micro base station according to claim 13, further comprising:
a judging unit configured to judge whether the mobile terminal is located in an extension region of a micro cell served by the micro base station;
the transmitting unit transmits activation information indicates an effective value to the mobile terminal when the mobile terminal is located in the extension region of the micro cell served by the micro base station, and the transmitting unit transmits activation information indicates an ineffective value to the mobile terminal when the mobile terminal is not located in the extension region of the micro cell served by the micro base station.

15. A macro base station, comprising:
a first transmitting unit configured to transmit information about Almost Blank Subframe (ABS) to a micro base station;
a receiving unit configured to receive from the micro base station data and information about a location of the data in the ABS; and
a second transmitting unit configured to transmit the data received by the receiving unit in the ABS according to the location designated by the information about the location received by the receiving unit.

16. A communication system, comprising:
a mobile terminal including
a receiving unit configured to receive from a micro base station a designation of specific subframe and a designation of feedback mode;
a judging unit configured to judge whether a current subframe is a specific subframe designated by the micro base station; and
a feeding back unit configured to measure and feed back the channel condition of the current subframe in a joint transmission feedback mode when the current subframe is the specific subframe designated by the micro base station, and measure and feed back the channel condition of the current subframe in a feedback mode designated by the micro base station when the current subframe is not the specific subframe designated by the micro base station,
a micro base station including
a receiving unit configured to receive from a macro base station information about Almost Blank Subframe (ABS) allocated to the macro base station, and receive channel feedback information from a mobile terminal;
a designating unit configured to designate a feedback mode, and designate a subframe used by the micro base station and corresponding to the ABS as a specific subframe;
a transmitting unit configured to transmit information about the specific subframe and the feedback mode to the mobile terminal, transmit data to the mobile terminal in the specific subframe, and transmit to the macro base station data to be transmitted by the macro base station to the mobile terminal in the ABS and a location of the data in the ABS;
a feedback processing unit configured to process the channel feedback information as channel feedback information in a joint transmission feedback mode when the received channel feedback information is for the specific subframe, and process the channel feedback information as channel feedback information in a feedback mode designated by the designating unit when the received channel feedback information is not for the specific subframe, and
a macro base station including
a first transmitting unit configured to transmit information about Almost Blank Subframe (ABS) to a micro base station;
a receiving unit configured to receive from the micro base station data and information about a location of the data in the ABS; and
a second transmitting unit configured to transmit the data received by the receiving unit in the ABS according to the location designated by the information about the location received by the receiving unit.
